(19) United States
(12) Patent Application Publication
(10) Pub. No.: US 2022/0187852 A1
(43) Pub. Date: Jun. 16, 2022

(54) VEHICLE, A METHOD FOR CONTROLLING A VEHICLE, A VEHICLE CONTROL SYSTEM AND A NETWORK NODE

(71) Applicant: Telefonaktiebolaget LM Ericsson (publ), Stockholm (SE)

(72) Inventors: Konstantinos Vandikas, SOLNA (SE); Yifei Jin, SOLNA (SE); Lackis Eleftheriadis, GÄVLE (SE); Yang Zuo, LULEÅ (SE)

(21) Appl. No.: 17/600,877

(22) PCT Filed: Apr. 2, 2019
(86) PCT No.: PCT/EP2019/058322

§ 371 Date: Oct. 1, 2021

(51) Int. Cl. G05D 1/10; G08G 5/00; H04W 72/12

(52) U.S. Cl. CPC G05D 1/106; B64C 27/20; H04W 72/1205; G08G 5/0039

(57) ABSTRACT

There is provided a system and a method for controlling a vehicle. A path is determined, to be followed by the vehicle between a starting location and an intended destination location. The vehicle is controlled to follow the determined path. An indication may be received from the vehicle of the presence of a potential difficulty in respect of the determined path. The method determines the source of any potential difficulty and interacts with the source thereby to re-configure at least one of the source and the vehicle to enable onward progress of the vehicle along the determined or an updated path. The system comprises a controller and a vehicle interface. The controller implements the method and interacts with the vehicle via the vehicle interface. The method and the system may control the vehicle to conduct a field service operation in respect of a network node of a wireless communications network.

### TECHNICAL FIELD

The proposed technology relates generally to an autonomous, partially autonomous or remotely-controlled vehicle, in particular a vehicle capable of flight, to a method for controlling a vehicle, for example from a remote location, to a vehicle control system and to a network node.

### BACKGROUND

It is known to make use of remotely controllable vehicles in support of inaccessible or dangerous operations. Such vehicles may include un-piloted aerial vehicles, e.g. unmanned aerial vehicles (UAVs) or ‘drones’, land vehicles or vehicles capable of operating on or below the surface of water.

It is also known for there to be difficulties in controlling such a vehicle, for example a UAV, e.g. to follow a predetermined flight path, when the UAV is flying through a region with high ambient levels of electromagnetic radiation. Such regions may for example surround cellular radio base stations, television or radio transmitters or high-power electrical transmission lines. Induced magnetic fields, in particular, may have an effect upon navigation sensors used by the UAV. Although specially equipped UAVs and other types of vehicle are available with electromagnetic shields designed to reduce the effects of electromagnetic interference, such variants are more expensive as a result.

It is known, for example from US patent application publication US 2017/0336806, to use remotely-controlled UAVs, or “Drones”, to carry out visual inspections of aerial structures. This may be achieved in that example by determining a minimum stand-off distance to be maintained by the UAV when flying around such structures. The stand-off distance is set to ensure that the UAV avoids undesirable effects of such electromagnetic radiation and to ensure that navigation control of the UAV can be maintained. However, the level of detail that may be captured in a visual inspection from such a stand-off distance may be limited.

### SUMMARY

According to a first aspect disclosed herein, there is provided a method for controlling a vehicle. The method comprises determining a path to be followed by the vehicle between a starting location and an intended destination location and controlling the vehicle to follow the determined path. It may be received from the vehicle an indication of the presence of a potential difficulty in respect of the determined path and the method comprises determining the source of the potential difficulty and interacting with the source of the potential difficulty thereby to re-configure at least one of the source and the vehicle to enable onward progress of the vehicle along the determined path or along an updated path.

Example embodiments disclosed herein enable a relatively low-cost vehicle, for example an un-protected UAV or ‘drone’, to be used in support of operations that require the vehicle to follow a particular path in order to fulfil an operational goal. With known methods for controlling a vehicle it may not be possible to position the vehicle as required. The required position may be a close approach to a source of high-power electromagnetic signals sufficiently close in frequency to cause disruption to communication with the vehicle or which may induce magnetic fields capable of disrupting navigation of the vehicle. By sensing a potential difficulty in respect of a determined path and overcoming the potential difficulty through interaction with a determined source of the potential difficulty, a path may be followed that enables the vehicle to fulfil an operational goal, without need for expensive electromagnetic shielding or other protective measures.

According to a second aspect disclosed herein, there is provided a system, configured for controlling a vehicle, the system comprising a controller and a vehicle interface to enable interaction between the controller and functionality implemented in the vehicle. The controller is configured to determine a path to be followed by a vehicle between a starting location and an intended destination location and to communicate, through the vehicle interface, control signals for controlling the vehicle to follow the determined path. The controller may receive via the vehicle interface an indication of the presence of a potential difficulty in respect of the determined path. The controller then determines the source of the potential difficulty and interacts with the source of the potential difficulty to re-configure at least one of the source and the vehicle to enable onward progress of the vehicle along the determined path or along a modified path.

According to a third aspect disclosed herein, there is provided a network node in a wireless communications network, configured to interact with a system for controlling a vehicle to follow a determined path, wherein the network node is configured thereby to determine and to agree with the system a change to a configuration of the network node to enable the vehicle to proceed along the determined path or along a modified path.

According to a fourth aspect disclosed herein, there is provided a vehicle, comprising a communications interface, one or more sensors, and a processor. The processor is configured: to receive, via the communications interface, data relating to a path to be followed by the vehicle; to transmit, via the communications interface, sensor data from the one or more sensors, indicative of a potential difficulty in respect of the path to be followed. Responsive to control signals received via the communications interface, the processor is configured to control the vehicle to follow the path or to follow a modified path.

### BRIEF DESCRIPTION OF DRAWINGS

Example embodiments of the proposed technology will now be described in more detail and with reference to the accompanying drawings of which:

FIG. 1 shows, in a schematic representation, an example of a field service scenario in which a vehicle and techniques disclosed herein may be applied;

FIG. 2 shows, in a schematic representation, an example of a UAV as may be used and controlled according to the present disclosure;

FIG. 3 is a flow chart showing an example of a process for conducting a field service operation using a UAV, according to the present disclosure;

FIG. 4 shows, in a schematic representation, an example of a radiation pattern emitted by antennas of a wireless network node relative to an intended flight path of a UAV;

FIG. 5 shows, in a schematic representation, functional blocks comprised in an example of a wireless network node that may be controlled according to the present disclosure; and

FIG. 6 shows, in a schematic representation, an example of a cloud-hosted system for the control of a UAV by a network operations centre, according to example embodiments disclosed herein.

### DETAILED DESCRIPTION

It is known to use autonomous, partially autonomous or remotely-controlled pilotless vehicles, i.e. the vehicle does not carry a pilot or driver of the vehicle, to assist in operations of various different types. These operations may include, for example, diagnostic, monitoring, configuration and provisioning operations which may be carried out conveniently with the assistance of such a vehicle. For example, the vehicle may be a vehicle capable of flying, known sometimes as a “Drone” or “UAV” (Unmanned Aerial Vehicle), a land-based vehicle or a vehicle designed to travel on or beneath the surface of water. The operations to be carried out using the vehicle may relate for example to field service operations in respect of wireless telecommunications network equipment, electrical power supply lines, radio or television broadcasting equipment, building services equipment, or to any equipment or structure for which assistance may conveniently be provided by a driverless or pilotless vehicle.

A suitably equipped UAV, for example, may assist with such operations by remote control or by implementing functionality for at least partially autonomous control of the UAV. By way of example only, the description of example embodiments that follow will relate to a UAV and to operation of a UAV. However, it will be clear to people of ordinary skill in relevant arts that the principles and functionality described herein may be applied to other types of vehicle, for example to those types indicated above.

UAVs may be provided with one or more sensors, for example with cameras, position sensors, electromagnetic sensors or other useful sensor devices. A UAV may store or communicate sensor data, for example: images from a camera; electromagnetic signal characteristics from an electromagnetic signal sensor; acoustic signals from a microphone; or location information from a position sensor. Such sensor data may be used in real-time or stored for subsequent use in support of the above-mentioned operations. If a UAV equipped with appropriate sensors is available to assist with such operations, it may be that a human is not required to be physically present, for example to climb an antenna structure to make a visual inspection of malfunctioning equipment. This may be advantageous where the intended operations involve remote or difficult-to-access locations or relate generally to a potentially unsafe operating environment.

In a typical operation involving a UAV, the UAV may be required to navigate from a starting location to a destination location. The path from starting location to destination location may pass via one or more selected waypoints. Having arrived at the destination location, the UAV may be required to perform one or more operations. In one example, a UAV equipped with a camera may be required to travel to a malfunctioning antenna structure and to provide close-up images of the antenna structure and associated equipment. If the UAV is equipped with an electromagnetic sensor, it may be required to make measurements of electromagnetic signals transmitted by the antenna structure at one or more locations around the antenna structure.

In carrying out the required operations or in following a selected path to the intended destination location, the UAV may be required to fly sufficiently close to an antenna structure or other source of electromagnetic signals for the electromagnetic signals to begin to affect navigation of the UAV or communication with the UAV. For example, high power signals may affect the communication of control signals to the UAV, or communication by the UAV of sensor data to a control centre, for example where the frequency of the transmitted signals are close to those used in control of the UAV. Alternatively, induced magnetic fields may affect navigation sensors or other location determining technology provided on the UAV. These difficulties may arise for example if the UAV is required to fly close to a transmitting antenna when following a predetermined flight path or in order to carry out an operation in respect of the antenna. In particular, the UAV may experience less predictable near-field effects of high-power electromagnetic fields when approaching a transmitting antenna from the particular direction of a lobe of high signal strength in the transmitted electromagnetic radiation pattern of the antenna. It may or may not be known in advance at what distance or from which direction such interference problems will begin.

Besides problems of electromagnetic interference, the UAV may also encounter other types of known or unknown restriction to onward progress along an intended path. Such restrictions may arise for example from a need to re-plan a path around another restriction, such as a high-power signal source. Other types of restriction may include proximity to a no-fly area such as an airport or high-security facility, a physical barrier, overhead electrical conductors or other wires which may be difficult to avoid safely by remote control.

A UAV developed especially for the purpose of operating in the presence of high strength electromagnetic signals, for example a UAV having shielding to provide a barrier to high-strength electromagnetic signals in particular frequency ranges, may provide one solution to the problem of maintaining control of the UAV or enabling the UAV to achieve its objectives. However, the shielding required to protect such UAVs is expensive. It may be undesirable to invest larger amounts of money in a UAV for use in the above-mentioned operations, in particular if the risk of loss or damage to the UAV due to crashing, or other cause, is high. A solution enabling a simpler and lower-cost UAV, or other type of vehicle, to be used is therefore desirable.

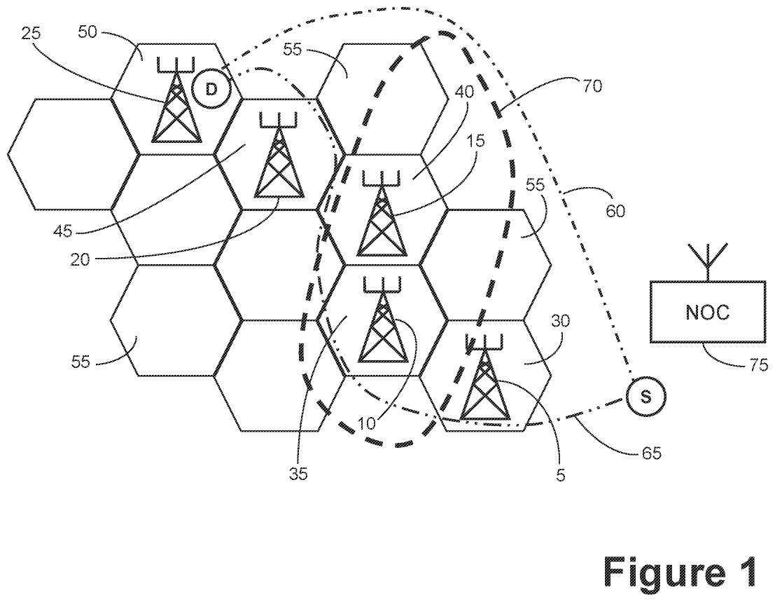

One example of a field service operation involving a UAV will now be described with reference to FIGS. 1, 2 and 3. In particular, an example operating scenario, a typical UAV and a summary of steps and considerations for conduct of a field service operation involving the UAV in that scenario will be described. In the example scenario, the UAV is required to fly from a starting location S to a destination location D where the main tasks of a field service operation are to be performed.

Referring initially to FIG. 1, a schematic representation is provided of one example scenario in which a field service operation is to be carried out upon base station or other wireless network node equipment of a cellular communications network. In this example scenario, an arrangement of network nodes 5, 10, 15, 20, 25 is shown. Each network node5-25 is configured to provide cellular radio coverage to respective areas represented by cells 30, 35, 40, 45, 50. Other cells 55 are served by respective network nodes not shown in FIG. 1.

For example, if a UAV is required to perform a field service operation at a destination D within the cell 50 served by the network node 25, the UAV is required to fly from a start location S to the destination location D along a flight path selected from one or more predetermined paths 60, 65. As discussed above, the paths 60, 65 may be determined to take account of a number of different factors, including potential difficulties that may affect progress of the UAV along each determined path 60, 65. Potential difficulties may for example include known physical barriers, proximity to high-power electromagnetic radiation sources such as the antennas of network nodes 5-25 or other sources not shown in FIG. 1, or a zone 70 where UAV flight is restricted.

One flight path is selected from the determined paths 60, 65. Flight of a UAV along the selected flight path 60, 65 may then be controlled from a network operations centre (NOC) 75 or from one or more other facilities within wireless communicating range of the UAV. The NOC 75 may receive sensor data from a UAV as it progresses and may communicate with the UAV during its flight along the selected path 60, 65 and when required to control an operation by the UAV when it arrives at the destination D.

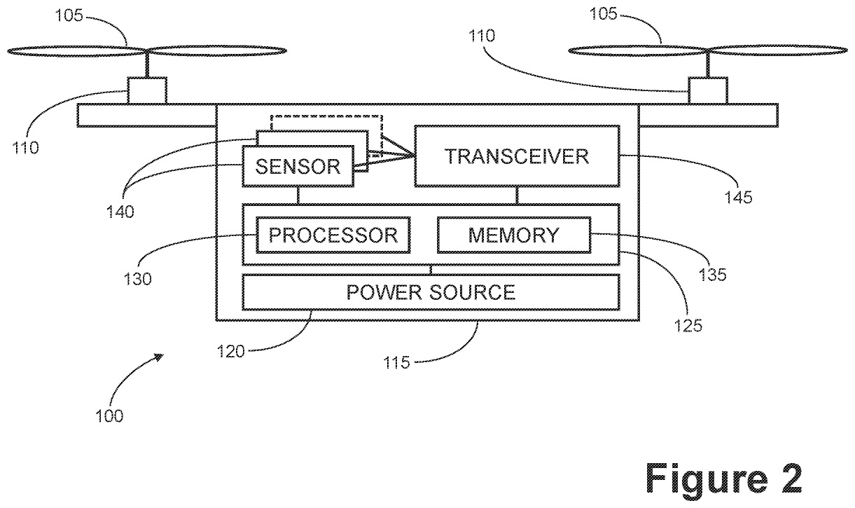

An example of a UAV that may be used to perform an operation, for example a field service operation in the scenario described above with reference to FIG. 1, will now be described additionally with reference to FIG. 2.

Referring to FIG. 2, a schematic representation is shown of components of an example UAV 100 as may be controlled as disclosed herein to perform such field service operations. The UAV 100 comprises a propulsion or lift system, in this example based upon one or more variable pitch rotors 105 linked to one or more propulsion motors 110. The propulsion motors 110 may for example be electric motors, internal combustions engines or other known form of controllable propulsion motor. The UAV 100 is provided with a housing 115 configured to carry a payload. The payload may for example include a power source 120, a controller 125 having a processor 130 and a memory 135, one or more sensors 140 and a transceiver 145. The power source 120 comprises a source of electrical power, for example a battery, to supply the controller 125, the sensor(s) 140 the transceiver 145 and, if electrically powered, the propulsion motors 110 and any pitch control actuators for the rotor(s) 105. The power source 120 may also include a fuel storage tank if the propulsion motors 110 are internal combustion engines or other fuel-based propulsion motors.

The memory 135 may be configured to store computer programs which may be accessed and executed by the processor 130 to implement control functions of the UAV 100. The control functions may include flight control of the UAV, in particular control of the propulsion motors 110 and variable pitch rotors 105 to enable autonomous, partially autonomous or fully remote-control of flight of the UAV 100 along a selected flight path 60, 65. The UAV 100 may communicate wirelessly, via the transceiver 145, for the receipt of flight control signals or other data, and for transmitting data from the UAV sensors 140 or other data generated by the processor 130. The flight control signals may for example comprise any one or more of real-time flight control signals, data relating to a flight path to be followed with at least partially autonomy by the UAV, or data related to a field service operation to be performed by the UAV 100. The processor 130 may cause sensor data to be transmitted via the transceiver 145, for example image data from a camera, position data from a position sensor or electromagnetic signal characteristics from an electromagnetic signal sensor. The processor 130 may generate other data for communication to a receiving party, resulting for example from the analysis of sensor data by the processor 130, and including messages and other interactions according to the functionality implemented by the processor 130.

In general, a UAV 100 may be provided with increased memory and data processing capability as compared with a basic UAV without significantly increasing the cost of the UAV. As will be discussed further in respect of example embodiments, below, some of the functionality associated with the control of the UAV 100 may be implemented within the UAV 100 itself.

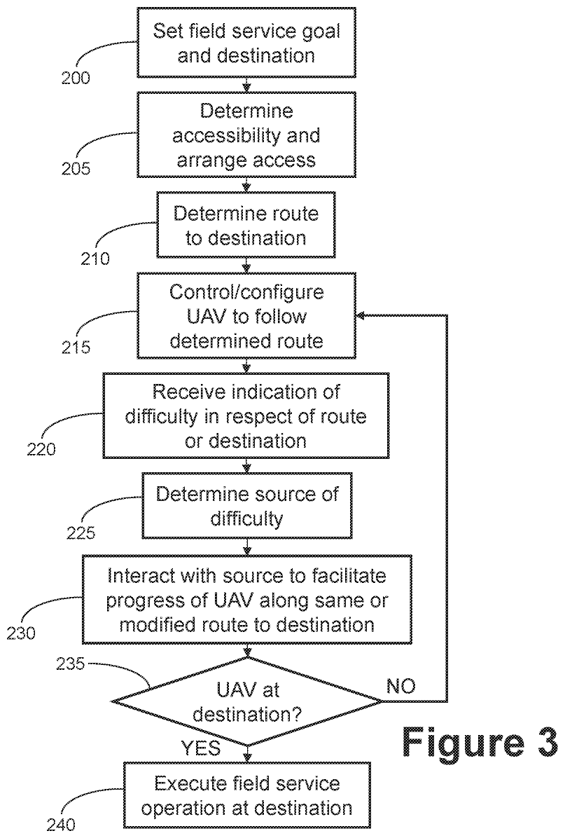

An example sequence of steps in a field service operation by a UAV 100 will now be described with reference to FIG. 3. In this example, the field service operation includes navigation of the UAV 100 from a start to a destination, as for example in the scenario shown in FIG. 1, and the execution of a field service operation at the destination. In this example, it is assumed that the NOC 75 determines the goals of the field service operation and controls the UAV 100 by wireless communication.

Referring additionally to FIG. 3, a flow chart is provided showing example steps in performing a field service operation involving a UAV 100. The field service operation in this example begins at 200 with an operator at the NOC 75, or other control authority, setting a field service goal and identifying the destination at which the field service operation is to be performed. The need to perform a field service operation at the destination may be due to receipt by the NOC 75 of a particular type of fault report, e.g. a ‘trouble ticket’, relating to network equipment at the destination. For example, a fault may have been indicated at a network node 25 of a cellular network, as for example in FIG. 1. The indicated fault may be due to physical damage to the network node 25; its antenna or associated equipment. The operator at the NOC 75 determines that a UAV 100 equipped with a camera and an electromagnetic sensor may be beneficial in helping to diagnose the cause of the fault. The goal of the field service operation may therefore be determined by the operator at the NOC 75, or by automated selection from a predetermined set of goals, to be the measurement of electromagnetic signals at different points in the vicinity of the antenna of the network node 25, and the capture of close-up images of the antenna structure and its associated equipment.

At 205, the NOC 75 determines accessibility by the UAV 100 at the destination based upon information available. For example, if the antenna structure is sited in an area in which UAV flights are restricted, this should be known to the NOC 75 in advance. Similarly, if it is known that the antenna of the network node 25 will be emitting electromagnetic signals of a high signal level in the vicinity of the antenna where the UAV 100 is likely to need to be to achieve the field service goals, this may be known to the NOC 75 before launch of the UAV 100 and may be taken into account when controlling the UAV 100. However, the exact pattern of radiation in the vicinity of the antenna may not be known to the NOC 75 in detail, in particular if the network node equipment is faulty.

At 210, with the destination known, the operator at the NOC 75 may determine one or more possible paths 60, 65 to the destination D based upon information available to the NOC 75. When determining the one or more possible paths 60, 65, the NOC 75 may take account of information about the destination location and characteristics of potential restrictions or difficulties between a launch location S for the UAV 100 and the destination D. Some examples of considerations, restrictions and difficulties as may be taken into account when determining possible paths 60, 65 at 210, have been mentioned above. The available information may relate to known sources of electromagnetic interference, for example the location of mobile communications network node transmitters, and other types of high-power transmitter. The available information may define regions in which UAV flights are prohibited, for example in the vicinity of airports, or where UAV flights are subject to controls and permissions for security or safety purposes. The available information enables one or more possible flight paths 60, 65 for the UAV 100 to be determined and for a flight path 60, 65 to be selected before launch of the UAV 100.

However, it may be that not all the information required to determine a path 60, 65 at 210 is known before launch of the UAV 100. Furthermore, it may not be known before launch that the UAV 100 will be able to follow the selected flight path 60, 65 without restriction. It may not be known in advance how a selected flight path 60, 65 will need to be modified during flight of the UAV, for example to pass through a restricted area. The UAV sensors may be required to provide sensor data during the flight to enable a controller at the NOC 75 to determine whether onward progress along a selected flight path 60, 65 is still possible and to enable an alternative flight path or a modification to the selected flight path 60, 65 to be determined if required. Such sensor data may, for example, determine the exact pattern of radiation or signal strength of a known source of electromagnetic signals, or detect a temporary obstruction or other hazard which may block onward progress of the UAV 100 along a selected flight path 60, 65 and provide the information required to determine a modification to the selected flight path 60, 65.

At 215, the UAV 100 may be launched, and an operator of the UAV 100 may control and configure the UAV 100 to follow a selected one of the paths 60, 65 determined at 210. For example, the UAV 100 may be flown by the operator at the NOC 75 by transmitting flight control signals in real-time to the UAV 100. The NOC operator may receive camera images and position sensor data transmitted in real-time by the UAV 100 to ensure that the UAV 100 follows the selected flight path 60, 65 and avoids collision with obstacles. Alternatively, if at least partially autonomous flight control functions are implemented by the UAV 100, then NOC operator may for example transmit to the UAV 100 a flight path description in a pre-agreed format, defining the selected flight path 60, 65 for example as a sequence of waypoints with position and altitude data.

At 220, as the UAV 100 progresses along the selected flight path 60, 65, or as the UAV 100 is conducting the field service operation at the destination D, the UAV 100 may transmit sensor data or other data indicating the presence of a potential difficulty in respect of the flight path being followed, or in respect of the destination D. For example, the indication may comprise: image data showing a physical obstacle preventing progress along the selected flight path 60, 65; position data indicating that the UAV 100 is about to cross into an area where flight is restricted (e.g. an area 70 as shown in FIG. 1); electromagnetic signals of a power level above a predetermined threshold level, or of a particular frequency; or other sensed indication of a potential difficulty. Alternatively, functionality implemented by the processor 130 in the UAV 100 may analyse UAV sensor data and generate an alert message including details of the potential difficulty which may be transmitted to the NOC 75.

At 225, on receiving the indication, an operator at the NOC 75 may determine the source of the potential difficulty. If the potential difficulty relates to a physical obstacle, then the obstacle itself may the source of the difficulty. Alternatively, the presence of the obstacle, e.g. a gate or other protective barrier, may be under the control of an operator. If the difficulty relates to an area 70 in which UAV flight is restricted, then the source may be an access controller or security office controlling access to the area 70 and with authority to grant or deny permission to enter the area 70 in particular circumstances. If the difficulty relates to detected electromagnetic signals at an above-threshold power level or of a problematic frequency, then the source will be the transmitter of such signals. The source of the difficulty may relate to a determined goal of the field service operation, for example the network node 25 at the intended destination D, or it may affect progress at some point along the selected flight path 60, 65 to the destination D.

Therefore, at 230, if a source of the indicated difficulty is identified, there may begin an interaction with the source and/or with an associated controller to facilitate onward progress of the UAV 100 or execution of the field service operation goals at the destination D. The interaction may, for example, be triggered by the NOC 75 or by functionality implemented in the UAV 100. The interaction may be controlled at least in part by respective human operators, or at least in part by functionality of an automated workflow.

In one example scenario, a selected flight path 60, 65 may be altered in-flight in response to sensor data supplied by one or more sensors provided on the UAV 100. An electromagnetic signal sensor may indicate that the ambient electromagnetic field strength within a predetermined frequency range is reaching a level at which communication with or navigation of the UAV 100 may become difficult. Alternatively, a position sensor provided on the UAV 100 may indicate that the UAV is approaching an area in which UAV flights are restricted, e.g. an airport perimeter. In a further alternative, a camera may sense that a physical object is present which may affect onward flight along a the selected flight path 60, 65. In each example it may be convenient to cause the UAV 100 to pause onward flight, by hovering or landing, while an alteration to the flight path is determined or until, for example, permission to proceed along the same or altered flight path can be obtained. Functionality to achieve an alteration of the flight path or to obtain permission to proceed may be implemented within the UAV 100. Alternatively, the functionality may be implemented within the NOC 75 or other remote facility in communication with the UAV 100. As a further alternative, the functionality may be distributed; a part being implemented within the UAV 100 and a part being implemented in the NOC 75 or other remote facility in communication with the UAV 100. An example response to each of a number of example difficulties will now discussed.

For example, if the difficulty relates to a physical obstacle, the UAV 100 may be controlled to determine the size and location of the obstacle. The UAV 100 may then communicate the determined size and location information to the NOC 75 so that the NOC 75 may determine a path around or above the obstacle, or may arrange for the obstacle to be removed. Meanwhile, onward progress of the UAV 100 may be paused, by hovering or my landing as appropriate.

If the difficulty relates to an area 70 in which UAV flight is restricted, the area 70 having an associated access controller or security office, then the interaction may comprise the NOC 75, or functionality implemented on the UAV 100 itself, communicating a simple request to follow the selected flight path 60, 65 through the area 70. A response may be received from the access controller or security office suggesting an alternative path through the area 70, or passage through the area 70 within a particular time period or a denial of access. The NOC 75, or the UAV 100, may propose an alternative path through the area 70 or the NOC 75 may simply determine a variation to the selected flight path 60, 65 to by-pass the restricted area 70. If the UAV 100 is controlled to follow the variation to the selected flight path, the UAV 100 may detect and indicate a new and unexpected difficulty which may be handled, as described above, according to the type of difficulty indicated, returning to step 220 of the process.

If the difficulty relates to sensed electromagnetic signals, the determined source may be a network node 25 in a cellular communications network maintained by the NOC 75. In that case, the NOC 75 is likely to have some control over the operation of the network node 25. For example, a negotiation session may be established by or via the NOC 75 with the determined source, e.g. the network node 25, to adjust the configuration of the network node 25, including rescheduling data traffic being handled currently by the network node, then adjusting characteristics of signals transmitted by the network node 25, or temporarily disabling the transmission of signals during the field service operation by the UAV 100. If not under the control of the NOC 75, then it is likely that there will be a corresponding controller associated with the electromagnetic signal source with whom the NOC 75, or functionality implemented in the UAV 100, may negotiate. The negotiation may comprise a simple request to follow the selected flight path to enable onward progress of the UAV 100 in achieving the field service goals defined at 200. Alternatively, the negotiation may follow a pre-determined sequence of requests, responses and analyses of responses until a solution can be agreed satisfying pre-determined conditions. Alternatively, the negotiation may comprise a more complex human-to-human interaction or an at least partially automated workflow to agree a solution to enable onward progress of the UAV 100. Examples of ways in which a cellular network node 25 may be controlled by an interaction at 230 to enable a UAV 100 to conduct a field service operation in the vicinity of an antenna of the network node 25 will be described in more detail below.

Having arranged, at 230, for the UAV 100 to proceed, for example along the selected flight path 60, 65, along a modified flight path, or to approach the intended object of the field service operation at the destination D, it is determined at 235 whether the UAV 100 has arrived at the intended destination D. If the UAV 100 has arrived at the intended destination D then, at 240, the UAV 100 executes the field service operation according to the goal set at 200 at the beginning of this process.

If, at 235, the UAV 100 has not yet reaching the intended destination D, then the process returns to 215 to continue control of the UAV 100 to follow the selected or modified flight path.

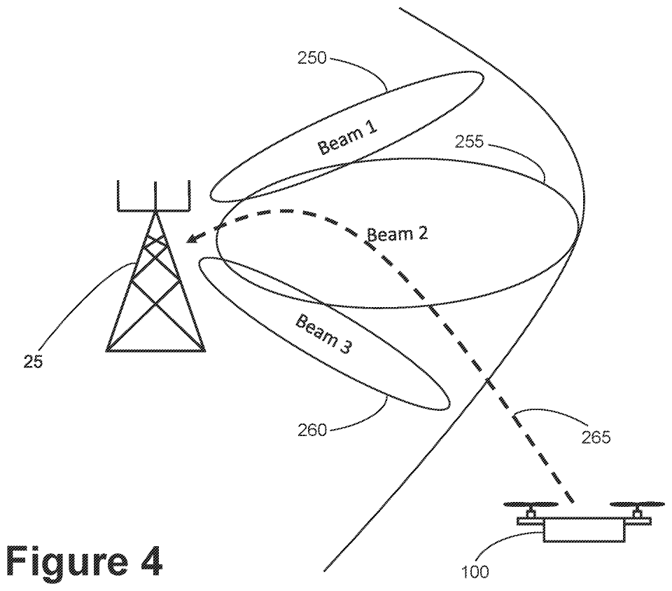

The example mentioned above of carrying out a field service operation at a destination D in the vicinity of an antenna of a network node 25 will now be described in further detail with reference to FIG. 4. In this example, it is assumed either that the UAV 100, at step 220 in the FIG. 3 process, has detected electromagnetic signals having a signal strength above a predetermined threshold, or that it was known in advance that signals of such a strength would be expected at a particular location and that the UAV 100 has now reached that location. It is also assumed, in this example, that the source of the signals has been identified as, or is already known to be, an antenna of the network node 25 where the field service operation is to be carried out.

Referring to FIG. 4, an example of a portion of a far-field electromagnetic radiation pattern emitted by antenna elements of the network node 25 is shown. The far-field radiation pattern comprises three main beams represented schematically by the beams 250, 255, 260. The signal power levels in the far-field radiation pattern vary according to the inverse square of distance from the antenna. Therefore, a UAV 100 approaching an antenna of the network node 25 along a flight path 265 would expect to experience an increasing intensity of electromagnetic radiation as it approaches the antenna of the network node 25 through the far-field radiation pattern 255 of Beam 2. An electromagnetic sensor provided on the UAV 100 may sense the signal strength as it progresses along the flight path 265, transmitting the sensed signal strength to the NOC 75, for example, or transmitting an alert message to the NOC 75 when the sensed signal power reaches a predetermined threshold.

At some point along the flight path 265, the effect of the signals transmitted by the network node 25 may increase to a level where further navigation of the UAV 100 along the flight path 265 becomes difficult. This may be for example when the UAV 100 reaches a point in the transmitted field 255 in beam 2 at which the UAV 100 experiences near-field characteristics of the field and the antenna. The near-field effects upon the UAV 100 may be less easily predicted in advance, being both different to the effects in the far-field and more severe. This should be apparent to the NOC 75 receiving the transmitted sensor data from the UAV 100. If the UAV 100 is required to approach to within a few metres of the antenna of the network node 25, for example to capture close-up images of the antenna or its associated equipment, the near-field effects of the transmitted signals may make it impossible to achieve the field service objective, unless the network node 25 can be controlled to modify the transmitted field in some way before those effects cause, for example, a loss of control of the UAV 100.

In one example, the network node 25 may be equipped with a Bluetooth® transceiver, a Wi-Fi transceiver or other type of short-range communication capability, whether based upon radio frequency or optical wavelengths. The network node 25 may include respective antenna elements or transducers to enable other entities such as the UAV 100 to communicate directly with the network node 25 from any location within range of the equipped communication capability. The UAV 100 may similarly be equipped with one or more of a Bluetooth®, Wi-Fi or other communicating transceiver. When the UAV 100 approaches to within a respective communicating range of the network node 25, functionality implemented in the UAV 100 and the network node 25 may be triggered to implement the negotiation step 230 of FIG. 3, communicating over a Bluetooth®, Wi-Fi or other short-range communication channel established between the UAV 100 and the network node 25. In this way, an appropriate re-configuration of the transmitted radiation pattern may be agreed to enable the UAV 100 to achieve its field service objective.

For example, as a result of a negotiation at step 230 of the process described above, it may be determined that the transmitted signal strength in the radiation pattern 255 of beam 2 needs to be reduced by 50% to enable the UAV 100 to approach. Alternatively, it may be determined that beam 2 needs to be switched off for a period of time until the UAV's field service has been completed. As a further alternative, it may be possible to control the network node 25 to vary the shape of the transmitted radiation pattern 255 of beam 2. As a further alternative, the network node 25 may be controlled to select carrier signals having frequencies that do not overlap with or that are not close to a frequency of communication by or with the UAV 100. Any one of these example solutions may be triggered by the NOC 75 or by functionality implemented on the UAV 100. The present disclosure therefore extends to a base station or other type of wireless network node that may be controlled to modify the transmitted far-field and/or near-field radiation of the network node 25 in the event that a UAV 100, as described above, is required to approach along an agreed flight path 265.

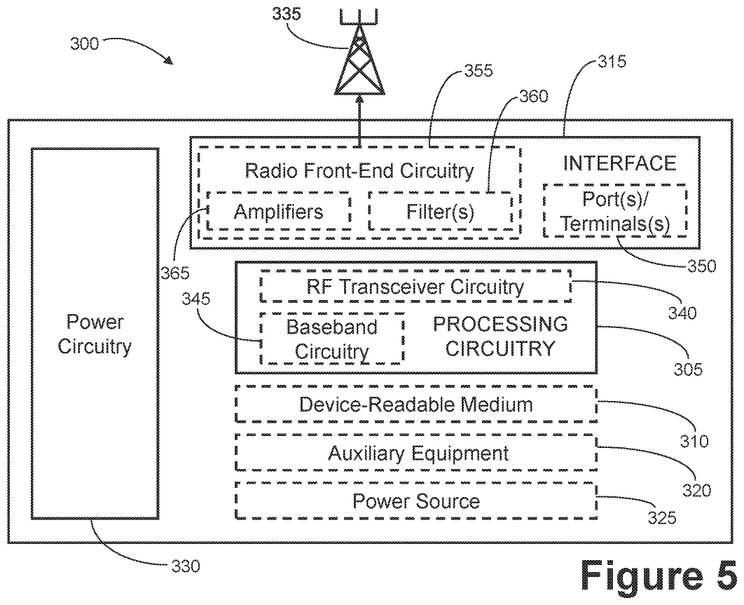

An example of a network node 25 of a cellular communications network, will now be described with reference to FIG. 5. The wireless network node may be arranged to provide wireless network access to mobile devices located within a respective cell of wireless coverage (e.g. the cell 50 shown in FIG. 1). The network node may be controlled according to the present disclosure to enable a UAV 100 to perform a field service operation in the vicinity of an antenna or other equipment of the network node.

Referring to FIG. 5, there are shown schematically components of a wireless network node 300 of a cellular communications network. The network node 300 may for example comprise a base station, being one example of a wireless network node that may be controlled according to the present disclosure. In its usual role, the network node 300 may provide communication and other types of services to one or more wireless devices within wireless communicating range of the node 300 to facilitate access by the wireless device to, and/or use of the services provided by, or via, the associated wireless network. The principles to be described below, relating to a method for controlling the network node 300 for the purposes of a field service objective described above, may be applied to this or any controllable source of electromagnetic signals to enable a vehicle to approach for the purposes of following a selected flight path or to carry out an operation in the vicinity of the source.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

The network node 300 comprises various components described in more detail below. These components work together in order to provide network node and/or wireless device functionality, such as providing wireless connections in the associated wireless network. As used herein, the term ‘network node’ refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, the network node 300 includes processing circuitry 305, a device-readable medium 310, an interface 315, auxiliary equipment 320, a power source 325, power circuitry 330, and an antenna 335. Although the network node 300 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of the network node 300 are depicted as single boxes located within a larger box, or nested within multiple boxes, in practice, a network node may comprise multiple different physical components that make up a single illustrated component (e.g., the device readable medium 310 may comprise multiple separate hard drives as well as multiple RAM modules).

Similarly, the network node 300 may be composed of multiple physically separate components (e.g., a NodeB component and an RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate device readable medium 310 for the different RATs) and some components may be reused (e.g., the same antenna 335 may be shared by the RATs). The network node 300 may also include multiple sets of the various illustrated components for different wireless technologies integrated into the network node 300, such as, for example, GSM, WCDMA, LTE, NR, Wi-Fi, or Bluetooth wireless technologies. These wireless technologies may be integrated into the same or different chip or set of chips and other components within the network node 300.

The processing circuitry 305 is configured to perform any determining, calculating, or similar operations (e.g., certain obtaining operations) described herein as being provided by a network node. These operations performed by the processing circuitry 305 may include processing information obtained by the processing circuitry 305 by, for example, converting the obtained information into other information, comparing the obtained information or converted information to information stored in the network node, and/or performing one or more operations based on the obtained information or converted information, and as a result of said processing making a determination.

In particular, in support of field service operations as may be performed by the UAV 100 or by another vehicle type, the processing circuitry 305 may implement control functions that may be triggered by an operator in the NOC 75, or by functionality implemented on the UAV 100. These control functions may for example implement actions at the network node 300 including, for example, one or more of:

adjusting the power of signals being transmitted by one or more elements of the antenna 335;

modifying the shape of one or more beams in the radiation pattern of signals transmitted by the antenna 335;

disabling the transmission of signals by one or more elements of the antenna 335;

locking the cell served by the network node and handing over the cell to a neighbouring network node, thereby disabling the transmission of signals by the antenna 335.

The actions implemented under the control of the processing circuitry 305 may have effect for a predetermined time period, for a time period specified during a negotiation phase, or from the time of receiving a first request message until the time at which the network node 300 receives a further request message to cancel the action. Action-triggering messages, or messages of a negotiation phase, may be exchanged between the NOC 75 and the network node 300, between the UAV 100 and the network node 300, or between the UAV 100 and the NOC 75. Such actions are intended to be implemented for as long as required for the UAV 100 to follow a selected flight path 60, 65 or a modified flight path relative the network node 300 or while conducting a field service operation in respect of the network node 300.

The processing circuitry 305 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide functionality of the network node 300, either alone or in conjunction with other components of the network node 300, such as the device readable medium 310. For example, the processing circuitry 305 may execute instructions stored in the device readable medium 310 or in memory within the processing circuitry 305. Such functionality may include providing any of the various wireless features, functions, or benefits discussed herein. In some embodiments, the processing circuitry 305 may include a system on a chip (SOC).

In some embodiments, the processing circuitry 305 may include one or more of radio frequency (RF) transceiver circuitry 340 and baseband processing circuitry 345. In some embodiments, the radio frequency (RF) transceiver circuitry 340 and the baseband processing circuitry 345 may be on separate chips (or sets of chips), boards, or units, such as radio units and digital units. In alternative embodiments, part or all the RF transceiver circuitry 340 and the baseband processing circuitry 345 may be on the same chip or set of chips, boards, or units.

In certain embodiments, some or all the functionality described herein as being provided by a network node, for example by a base station, eNB or other such network device, may be performed by the processing circuitry 305 executing instructions stored on the device readable medium 310 or memory within the processing circuitry 305. In alternative embodiments, some or all the functionality may be provided by the processing circuitry 305 without executing instructions stored on a separate or discrete device readable medium, such as in a hard-wired manner. In any of those embodiments, whether executing instructions stored on a device readable storage medium or not, the processing circuitry 305 can be configured to perform the described functionality. The benefits provided by such functionality are not limited to the processing circuitry 305 alone or to other components of the network node 300, but are enjoyed by the network node 300 as a whole, and/or by end users and the wireless network generally.

The device readable medium 310 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD), and/or any other volatile or non-volatile, non-transitory device readable and/or computer-executable memory devices that store information, data, and/or instructions that may be used by the processing circuitry 305. The device readable medium 310 may store any suitable instructions, data or information, including a computer program, software, an application including one or more of logic, rules, code, tables, etc. and/or other instructions capable of being executed by the processing circuitry 305 and, utilized by the network node 300. The device readable medium 310 may be used to store any calculations made by the processing circuitry 305 and/or any data received via the interface 315. In some embodiments, the processing circuitry 305 and the device readable medium 310 may be considered to be integrated.

The interface 315 is used in the wired or wireless communication of signalling and/or data between the network node 300, the associated network, and/or any wireless devices located within the respective cell served by the network node 300. For example, the interface 315 may be used to communicate wirelessly with a UAV 100 flying within communicating range of the network node 300. Such communications may comprise an exchange of data over a Bluetooth or other wireless connection between the UAV 100 and the interface 315.

As illustrated, the interface 315 comprises port(s)/terminal(s) 350 to send and receive data, for example to and from the associated network over a wired connection. The interface 315 also includes radio front end circuitry 355 that may be coupled to, or in certain embodiments be a part of, the antenna 335. The radio front end circuitry 355 comprises filters 360 and amplifiers 365. The radio front end circuitry 355 may be connected to the antenna 335 and the processing circuitry 305. The radio front end circuitry 355 may be configured to condition signals communicated between the antenna 335 and the processing circuitry 305. The radio front end circuitry 355 may receive digital data that is to be sent out to other network nodes or wireless devices via a wireless connection. The radio front end circuitry 355 may convert the digital data into a radio signal having the appropriate channel and bandwidth parameters using a combination of the filters 360 and/or the amplifiers 365. The radio signal may then be transmitted via the antenna 335. Similarly, when receiving data, the antenna 335 may collect radio signals which are then converted into digital data by the radio front end circuitry 355. The digital data may be passed to the processing circuitry 305. In other embodiments, the interface 315 may comprise different components and/or different combinations of components.

In certain alternative embodiments, network node 300 may not include separate radio front end circuitry 355. Instead, the processing circuitry 305 may comprise radio front end circuitry and may be connected to the antenna 335 without the separate radio front end circuitry 355. Similarly, in some embodiments, all or some of the RF transceiver circuitry 340 may be considered a part of the interface 315. In still other embodiments, the interface 315 may include one or more ports or terminals 350, radio front end circuitry 355, and RF transceiver circuitry 340, as part of a radio unit (not shown). The interface 315 may communicate with the baseband processing circuitry 345, which is part of a digital unit (not shown).

The antenna 335 may include one or more antennas, or antenna arrays, configured to send and/or receive wireless signals. The antenna 335 may be coupled to the radio front end circuitry 315 and may be any type of antenna capable of transmitting and receiving data and/or signals wirelessly. In some embodiments, the antenna 335 may comprise one or more omni-directional, sector or panel antennas operable to transmit/receive radio signals between, for example, 2 GHz and 66 GHz. An omni-directional antenna may be used to transmit/receive radio signals in any direction. A sector antenna may be used to transmit/receive radio signals from devices within a particular area. A panel antenna may be a line of sight antenna used to transmit/receive radio signals in a relatively straight line. In some instances, the use of more than one antenna may be referred to as MIMO. In certain embodiments, the antenna 335 may be separate from the network node 300 and may be connectable to the network node 300 through an interface or port.

The antenna 335, the interface 315, and/or the processing circuitry 305 may be configured to perform any receiving operations and/or certain obtaining operations described herein as being performed by a network node. Any information, data and/or signals may be received from a wireless device, another network node and/or any other network equipment. Similarly, the antenna 335, the interface 315, and/or the processing circuitry 305 may be configured to perform any transmitting operations described herein as being performed by a network node. Any information, data and/or signals may be transmitted to a wireless device, another network node and/or any other network equipment.

In the examples described herein, communication with the network node 300 may be established by the UAV 100 using Bluetooth communications, in particular if the UAV 100 is conducting a field service operation in sufficient proximity to the network node 300 to be within range of a Bluetooth communication. Alternatively, communication may be established between the UAV 100 and the network node 300 via the NOC 75. In a further alternative, all communication for the purposes of controlling the network node 300 to enable achievement of the field service goals by the UAV 100 may be conducted by the NOC 75 using established communications processes between the NOC 75 and the network node 300.

The power circuitry 330 may comprise, or be coupled to, power management circuitry and is configured to supply the components of the network node 300 with power for performing the functionality described herein. The power circuitry 330 may receive power from the power source 325. The power source 325 and/or the power circuitry 330 may be configured to provide power to the various components of the network node 300 in a form suitable for the respective components (e.g., at a voltage and current level needed for each respective component). The power source 325 may either be included in, or external to, the power circuitry 330 and/or the network node 300. For example, the network node 300 may be connectable to an external power source (e.g., an electricity outlet) via an input circuitry or interface such as an electrical cable, whereby the external power source supplies power to the power circuitry 330. As a further example, the power source 325 may comprise a source of power in the form of a battery or battery pack which is connected to, or integrated in, the power circuitry 330. The battery may provide backup power should the external power source fail. Other types of power sources, such as photovoltaic devices, may also be used.

Alternative embodiments of the network node 300 may include additional components beyond those shown in FIG. 5 that may be responsible for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

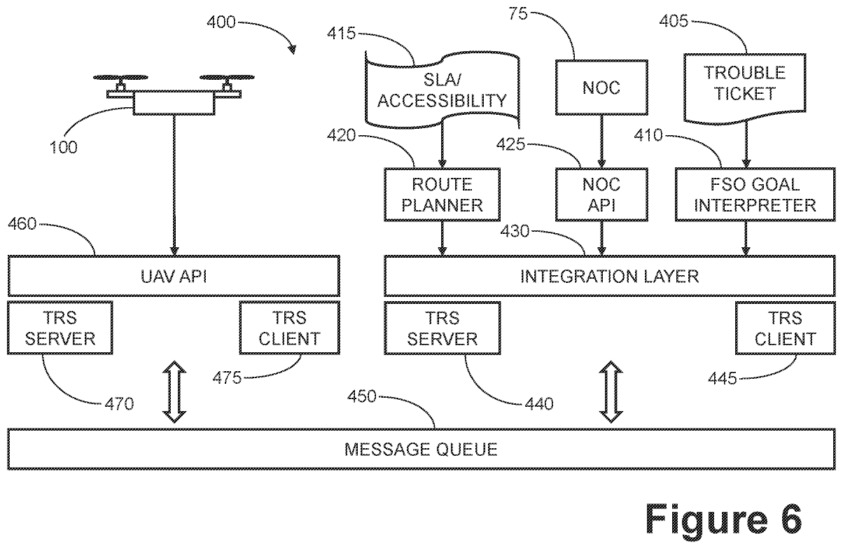

There will now be described, with reference to FIG. 6, one possible implementation of a cloud-based communication and operations management system by which the NOC 75 or a network node 300 may interact with a UAV 100 to perform functions as described above, to enable the objectives of a field service or other defined operation to be achieved. Such a system may be used more generally with vehicle types other than UAVs.

Referring to FIG. 6, a block diagram is provided showing the principle functional blocks in an example implementation of an at least partially cloud-hosted system 400 in which a UAV 100 and the NOC 75 (or other type of controlling entity), may operate and interact through a set of cloud-hosted components to achieve a field service operation (FSO) goal. For the purposes of describing this example system 400, the FSO goal may relate to a relevant entity in a wireless communications network.

A field service operation, for example the field service operation described above with reference to FIG. 3, may be implemented by the system 400. The operation may be triggered by the receipt of a ‘trouble ticket’ 405. The trouble ticket 405 may, for example, indicate a fault or other type of incident in a predetermined set of fault types or incidents that may occur in a wireless communications network. The fault or incident may for example relate to a network node 300 (not shown in FIG. 6). The trouble ticket 405 may be generated automatically or it may be generated by a human operator, for example an operator in a NOC 75 interpreting an indication of a fault or incident in the network. According to the information content of the trouble ticket 405, a field service operation (FSO) goal interpreter component 410 is provided to determine an FSO goal appropriate to the fault or incident identified in a received trouble ticket 405. The FSO goal determined by the FSO goal interpreter 410 may relate at least in part to what may be achieved by a UAV 100.

The system 400 includes a service level agreement (SLA) and accessibility component 415 configured to capture and to maintain a record of SLAs and accessibility relating to operations involving a UAV 100. The record 415 may for example define procedures for gaining access to particular areas through which a UAV 100 may be required to travel in order to access particular items of network equipment. The record 415 may for example define areas through which the UAV 100 is permitted to travel and areas to be avoided. The record 415 may for example define known sources of difficulty likely to affect the planning of routes for travel by a UAV 100. For example, the record 415 may define the position and identity of sources of high-power electromagnetic signals or known physical barriers.

The system 400 includes a route planning component 420, configured to access the record 415 and to use the information contained in the record 415 when it is required to plan a route for travel of a UAV 100, from a starting location to a destination location, in support of a particular FSO goal.

The system 400 includes a NOC application programmers' interface (API) 425 to enable the NOC 75 to interact with other components in the system 400, as required.

The system 400 includes an integration layer 430 implementing, for example, functionality according to a functional standard, or implementing bespoke functionality, to enable interaction between the three functional blocks 410, 420, 425 identified above, and with other components of the system 400 to be discussed further below. In one example implementation, machine-readable data definitions according to the Open Services for Lifecycle Collaboration (OSLC) standard may be generated to define and manage interactions between components of the system and, in particular, interactions with the UAV 100. For example, OSLC data definitions may be implemented in examples of the route planner component 420, the NOC API 425 or the FSO Goal Interpreter 410. Other known standard machine-readable data definition standards that may be used as an alternative to OSLC include the Web Ontology Language (OWL) and the Resource Description Framework (RDF). Also associated with the integration layer 430 in this example are a Tracked Resource Set (TRS) server 440 and a TRS client 445. The TRS components 440, 445 are configured to track changes to data published to and received from a message queue 450.

In an example implementation, the logically distinct components described above, that is, the service level agreement (SLA) and accessibility component 415, the route planning component 420, the NOC application programmers' interface (API) 425 and, optionally, the integration layer 430, or any combination of those components, may be implemented as a single ‘controller’ component. The controller component may be configured to operate according to the requirements of the NOC 75, or it may be configured to implement an at least partially automated process for the control of a UAV 100 or other vehicle type to achieve a determined FSO goal.

To enable an interaction between components in the system 400 and a UAV 100, the system 400 includes a UAV API 460 providing a common interface to functions and capabilities of UAVs 100 from different manufacturers that may be used in this system 400. The UAV API 460 may be configured, in one example implementation, to use data definitions according to the Open Services for Lifecycle Collaboration (OSLC) standard, to provide an interface to a range of UAV functions and capabilities. In particular, the OSLC data definitions may implement a software abstraction of a UAV 100 that is to be used for a current field service operation. The software abstraction of the UAV 100 may be used to manage the life-cycle of the UAV 100, from take-off to landing and achievement of an identified FSO goal. The software abstraction is created at the start of the field service operation and is destroyed when an identified FSO goal is achieved and the UAV 100 has landed. The range of functions and capabilities supported by the UAV API 460 may include functions and capabilities provided by all, or by only some of the different UAVs 100 that may be available. In this example, a TRS server 470 and a TRS client 475 are associated with the UAV API 460 to track changes to data published to and received from a message queue 450.

The TRS components 440, 445 associated with the integration layer 430 and the TRS components 470, 475 associated with the UAV API 460, implement a publish-and-subscribe protocol for exchanging messages and data between the UAV API 460 and the other components 410, 420, 425 via the message queue 450. The TRS components may query the message queue at regular intervals to check for new data published to the message queue by one of the other components 410, 420, 425, 460.

The system 400 provides a framework for controlling the UAV 100, for example to achieve an identified FSO goal triggered by the receipt of a trouble ticket 405. A field service operation by a UAV 100 may be controlled by the NOC 75, or by functionality implemented on the UAV 100, or by a mixture of functionality implemented by the NOC 75 and the UAV 100, in combination with functionality implemented by other components of the system 400. As discussed above, particular functions required to manage the operation of the UAV 100 or other components of the system 400 to achieve an identified FSO goal, may be implemented using the OSLC data definitions mentioned above.

Example embodiments as disclosed herein have been described in the example context of a UAV and the achievement of field service operational goals in respect of components of a wireless communications network. However, as would be apparent to a person of ordinary skill in the relevant art, the principles disclosed above may equally be applied to other scenarios in which a vehicle may usefully be applied in support of an operation. The vehicle may be controlled or piloted by a person being carried by the vehicle, or the vehicle may not carry a pilot or driver, e.g. a UAV. In either case, the embodiments described above may be applied to help in controlling the vehicle to achieve its operational goal(s).

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for controlling a UAV, comprising:
determining a path to be followed by the UAV between a starting location and an intended destination location;
controlling the UAV to follow the determined path;
receiving from the UAV an indication of the presence of radio-frequency, RF, electromagnetic radiation representing a potential difficulty in respect of the determined path;
determining the source of the RF electromagnetic radiation; and
interacting with the source of the RF electromagnetic radiation thereby to re-configure at least one of the source and the UAV to enable onward progress of the UAV along the determined path or along an updated path.

2. The method according to claim 1, wherein the indication of a potential difficulty comprises an indication of that the RF electromagnetic radiation is likely to affect control of the UAV.

3. The method according to claim 2, wherein the source comprises a controllable source of the RF electromagnetic radiation.

4. The method according to claim 1, wherein the indication of a potential difficulty comprises location information indicative of proximity of the UAV to a restricted area.

5. The method according to claim 4, wherein the source comprises an access controller for the restricted area.

6. The method according to claim 1, wherein interacting with the source of RF electromagnetic radiation comprises triggering a negotiation with the source thereby to re-configure the source to reduce the effect of the RF electromagnetic radiation in respect of the determined path or to agree an update to the determined path.

7. The method according to claim 6, wherein triggering the negotiation with the source of RF electromagnetic radiation comprises triggering a negotiation with functionality configured to control a configuration of the source of RF electromagnetic radiation.

8. The method according to claim 6, wherein the source of RF electromagnetic radiation comprises a controllable source of RF electromagnetic radiation and wherein triggering the negotiation comprises requesting a change to the emission of RF electromagnetic radiation by the source.

9. The method according to claim 8, wherein the change to the emission of RF electromagnetic radiation comprises at least one of: reducing the power of RF electromagnetic radiation emitted by the source; reducing the power of RF electromagnetic radiation in one of more beams transmitted by the source; changing the frequency of one or more carrier signals being transmitted by the source; and suspending transmission of RF electromagnetic radiation by the source.

10. The method according to claim 1, comprising, responsive to receiving an indication of the presence of a potential difficulty, causing operation of the UAV to pause while interacting with a determined source of the RF electromagnetic radiation.

11. The method according to claim 1, wherein the method comprises controlling the UAV to perform a field service operation in respect of a network node of a wireless cellular communications network, the network node including one or more antenna elements.

12. The method according to claim 11, wherein the network node is transmitting RF electromagnetic signals from its one or more antenna elements likely to cause a potential difficulty to the UAV following the predetermined path and wherein interacting with the source of the potential difficulty comprises interacting with the network node to:
re-schedule data traffic being handled by the network node; and
change the emission of RF electromagnetic signals by the network node.

13. A system, configured for controlling a UAV, comprising:
a controller; and
a UAV interface to enable interaction between the controller and functionality implemented in the UAV,
wherein the controller is configured:
to determine a path to be followed by a UAV between a starting location and an intended destination location;
to communicate, through the UAV interface, control signals for controlling the UAV to follow the determined path;
to receive via the UAV interface an indication of the presence of radio-frequency, RF, electromagnetic radiation representing a potential difficulty in respect of the determined path;
to determine the source of the RF electromagnetic radiation; and
to interact with the source of the RF electromagnetic radiation to re-configure at least one of the source and the UAV to enable onward progress of the UAV along the determined path or along a modified path.

14.-29. (canceled)

30. A network node in a wireless communications network, configured to interact with a controller of a UAV to cause the UAV to follow a determined path, wherein the network node is configured thereby to determine and to agree via the controller of the UAV a change to a configuration of the network node to enable the UAV to proceed along the determined path or along a modified path.

31. The network node according to claim 30, comprising a Bluetooth or a Wi-Fi interface and configured to communicate via a respective interface with the UAV, located within a respective communicating range of the network node, thereby to interact with the UAV to determine and to agree the change to a configuration of the network node.

32. The network node according to claim 30, configured to make a configuration change at the network node comprising at least one of: re-scheduling data traffic currently being handled by the network node; reducing the power of RF electromagnetic signals emitted by the network node; reducing the power of RF electromagnetic signals in one of more beams transmitted by the network node; changing the frequency of one or more carrier signals being transmitted by the network node; and suspending transmission of RF electromagnetic signals by the network node.

33. A UAV, comprising:
a communications interface;
one or more sensors; and
a processor configured:
to receive, via the communications interface, data relating to a path to be followed by the UAV;
to transmit, via the communications interface, sensor data from the one or more sensors, indicative of a source of radio-frequency, RF, electromagnetic radiation representing a potential difficulty in respect of the path to be followed;
responsive to control signals received via the communications interface, to control the UAV to follow the path or to follow a modified path.

34. The UAV according to claim 33, comprising a short-range communications interface for use in communicating with the source of RF electromagnetic radiation in respect of the path to be followed by the UAV, the processor being configured to trigger a negotiation with the source of RF electromagnetic radiation thereby to re-configure the source to reduce the effect of the RF electromagnetic radiation in respect of the determined path by at least one of:
reducing the power of RF electromagnetic radiation emitted by the source;
reducing the power of RF electromagnetic radiation in one of more beams transmitted by the source;
changing the frequency of one or more carrier signals being transmitted by the source;
suspending transmission of RF electromagnetic radiation by the source; and
agreeing an update to the determined path.

35. The UAV according to claim 34, wherein the source of RF electromagnetic radiation is a network node of a wireless cellular communications network, the network node including one or more antenna elements, and the processor is further configured to control the UAV to perform a field service operation in respect of the network node.
